(19) United States
(12) Patent Application Publication
(10) Pub. No.: US 2023/0267941 A1
(43) Pub. Date: Aug. 24, 2023

(54) Personalized Accent and/or Pace of Speaking Modulation for Audio/Video Streams

(71) Applicant: Bank of America Corporation, Charlotte, NC (US)

(72) Inventors: Abhishek Nagpal, Gurugram (IN); Nanthakumar Veerasamy, Hyderabad (IN)

(21) Appl. No.: 17/679,629

(22) Filed: Feb. 24, 2022

(51) Int. Cl. G10L 21/007; G10L 15/06; G10L 25/57; G10L 15/22; G06N 5/02

(52) U.S. Cl. CPC G10L 21/007; G10L 15/063; G10L 25/57; G10L 15/22; G06N 5/022; G10L 2015/0635

(57) ABSTRACT

Aspects of the disclosure relate to generating personalized accent and/or pace of speaking modulation for audio/video streams. In some embodiments, a computing platform may train an artificial intelligence model on audio or video samples associated with different geographic regions. The computing platform may receive, via a communication interface, an audio or video stream associated with a first geographic region. The computing platform may identify a second geographic region different from the first geographic region. The computing platform may transform the audio or video stream to correspond to the second geographic region different from the first geographic region. The computing platform may send, via the communication interface, the transformed audio or video stream to a user device associated with the second geographic region.

### BACKGROUND

Aspects of the disclosure generally relate to one or more computer systems, servers, and/or other devices including hardware and/or software. In particular, one or more aspects of the disclosure relate to generating personalized accent and/or pace of speaking modulation for audio/video streams.

Voice conversations between individuals from different geographic regions may be complicated by the accents and/or pace of speaking of individuals whose native language is different from a common language being used in a particular conversation. In many instances, it may be difficult to use conventional tools to achieve efficient and effective communications due to speech variations between individuals such as differences in accent and/or pace of speaking, among other factors. For example, it may be difficult to adjust playback speech audio to an expected or desired accent and/or pace of speaking. Conventional tools merely allow users to change a playback speed of an audio/video segment in an unnatural way.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with generating personalized accent and/or pace of speaking modulation for audio/video streams. In accordance with one or more embodiments, a computing platform having at least one processor, a communication interface, and memory may train an artificial intelligence model on audio and/or video samples associated with different geographic regions. The computing platform may receive, via the communication interface, an audio and/or video stream associated with a first geographic region. The computing platform may identify a second geographic region different from the first geographic region. The computing platform may transform the audio and/or video stream to correspond to the second geographic region. The computing platform may send, via the communication interface, the transformed audio and/or video stream to a user device associated with the second geographic region.

In some embodiments, training an artificial intelligence model on audio and/or video samples associated with different geographic regions may include training the artificial intelligence model to detect different user accents or paces of speaking.

In some arrangements, the audio and/or video stream may be associated with a live webcast initiated in the first geographic region and broadcast to user devices located in the second geographic region.

In some examples, the audio and/or video stream may be associated with a natural language interaction application.

In some embodiments, transforming the audio and/or video stream to correspond to the second geographic region may include detecting an accent and/or pace of speaking of a particular user, and adapting responses to the accent and/or pace of speaking of the particular user.

In some example arrangements, transforming the audio and/or video stream to correspond to the second geographic region may include applying the trained artificial intelligence model to convert input speech into a particular accent and/or pace of speaking.

In some examples, sending the transformed audio and/or video stream to the user device associated with the second geographic region may include sending a transformed audio and/or video stream with modulated audio or voice data.

In some embodiments, the computing platform may receive user feedback and update the artificial intelligence model based on the user feedback.

In some embodiments, the audio and/or video stream may be associated with a live or recorded audio and/or video stream.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for generating personalized accent and/or pace of speaking modulation for audio/video streams in accordance with one or more example embodiments;

FIGS. 2A-2D depict an illustrative event sequence for generating personalized accent and/or pace of speaking modulation for audio/video streams in accordance with one or more example embodiments;

FIGS. 3 and 4 depict example graphical user interfaces for generating personalized accent and/or pace of speaking modulation for audio/video streams in accordance with one or more example embodiments; and

FIG. 5 depicts an illustrative method for generating personalized accent and/or pace of speaking modulation for audio/video streams in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to intelligent generation of personalized accent and/or pace of speaking modulation for audio/video streams. In particular, one or more aspects of the disclosure may provide a custom-tailored user experience by mimicking the accent and/or pace at which a user speaks and/or understands (e.g., English with a non-English language accent, English with a British accent, etc.). Additional aspects of the disclosure may take audio inputs from the user and perform the modulation on real-time or recorded audio and/or video. Additional aspects of the disclosure may take audio inputs from the user and perform the modulation on voice chatbots. Further aspects of the disclosure may apply a machine learning process to optimize system performance based on learned data.

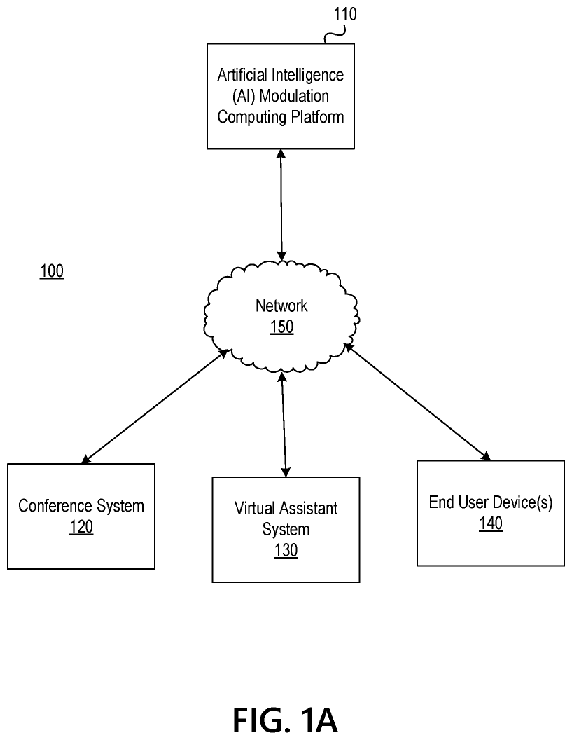

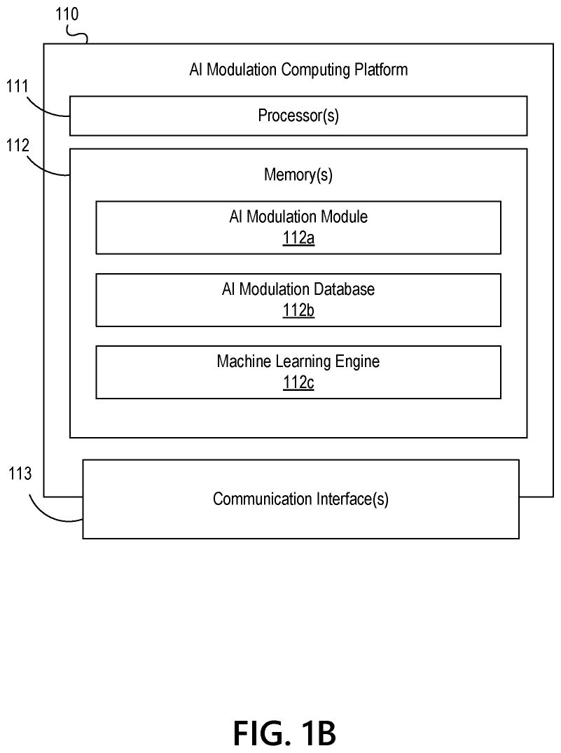

FIGS. 1A and 1B depict an illustrative computing environment for generating personalized accent and/or pace of speaking modulation for audio/video streams in accordance with one or more example arrangements. Referring to FIG. 1A, computing environment 100 may include one or more devices (e.g., computer systems, communication devices, servers). For example, computing environment 100 may include an artificial intelligence (AI) modulation computing platform 110, a conference system 120, a virtual assistant system 130, and an end user device 140. Although one user device 140 is shown for illustrative purposes, any number of user devices may be used without departing from the disclosure.

As illustrated in greater detail below, AI modulation computing platform 110 may include one or more computing devices configured to perform one or more of the functions described herein. For example, query analysis computing platform 110 may include one or more computers (e.g., laptop computers, desktop computers, servers, server blades, or the like) that may be used to perform machine learning and/or training on different accents and/or paces of speaking. In some examples, AI modulation computing platform 110 may perform audio/video modulation of the accent and/or pace of speaking (e.g., varying a tone, stress on words, pitch, and/or rate of speech).

Conference system 120 may be and/or include a video conference server and system. For instance, conference system 120 may be used by two or more participants (e.g., in a web conferencing meeting) who are participating from different locations. For instance, conference system 120 may be and/or include a camera and a display system that captures video and/or audio of conference-room participants and displays video feeds.

Virtual assistant system 130 may be and/or include an artificial intelligence-based virtual/voice assistant application (e.g., chatbot). In such applications, a predetermined term or phrase is spoken by the user to activate/awaken the application. These systems or applications may be managed or otherwise operated AI modulation computing platform 110 (which may be the system performing one or more of the steps in process 500), where the managing entity system accesses a knowledge base, a customer profile, a database of customer information (e.g., including account information, transaction history, user history, or the like) to provide prompts, questions, and responses to user input based on certain logic rules and parameters.

End user device 140 may include one or more end user computing devices and/or other computer components (e.g., processors, memories, communication interfaces) for transmitting/receiving audio and/or video content that might be modulated by AI modulation computing platform 110. For instance, end user device 140 may be and/or include a customer mobile device, a financial center device, and/or the like where audio and/or video are played back.

Computing environment 100 also may include one or more networks, which may interconnect one or more of AI modulation computing platform 110, conference system 120, virtual assistant system 130, and end user device 140. For example, computing environment 100 may include a network 150 (which may, e.g., interconnect AI modulation computing platform 110, conference system 120, virtual assistant system 130, end user device 140, and/or one or more other systems which may be associated with an enterprise organization, such as a financial institution, with one or more other systems, public networks, sub-networks, and/or the like).

In one or more arrangements, AI modulation computing platform 110, conference system 120, virtual assistant system 130, and end user device 140 may be any type of computing device capable of receiving a user interface, receiving input via the user interface, and communicating the received input to one or more other computing devices. For example, AI modulation computing platform 110, conference system 120, virtual assistant system 130, end user device 140, and/or the other systems included in computing environment 100 may, in some instances, include one or more processors, memories, communication interfaces, storage devices, and/or other components. As noted above, and as illustrated in greater detail below, any and/or all of AI modulation computing platform 110, conference system 120, virtual assistant system 130, and end user device 140 may, in some instances, be special-purpose computing devices configured to perform specific functions.

Referring to FIG. 1B, AI modulation computing platform 110 may include one or more processors 111, memory 112, and communication interface 113. A data bus may interconnect processor 111, memory 112, and communication interface 113. Communication interface 113 may be a network interface configured to support communication between AI modulation computing platform 110 and one or more networks (e.g., network 150, or the like). Memory 112 may include one or more program modules having instructions that when executed by processor 111 cause AI modulation computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of AI modulation computing platform 110 and/or by different computing devices that may form and/or otherwise make up AI modulation computing platform 110. For example, memory 112 may have, host, store, and/or include an AI modulation module 112a, AI modulation database 112b, and machine learning engine 112c.

AI modulation module 112a may have instructions that direct and/or cause AI modulation module 112a to learn and/or train on different accents and/or paces of speaking, perform audio/video modulation, and/or perform other functions, as discussed in greater detail below. AI modulation database 112b may store information used by AI modulation module 112a and/or AI modulation computing platform 110 in generating personalized accent and/or pace of speaking modulation for audio/video streams. Machine learning engine 112c may have instructions that direct and/or cause AI modulation computing platform 110 to set, define, and/or iteratively redefine rules, techniques and/or other parameters used by AI modulation computing platform 110 and/or other systems in computing environment 100 in generating personalized accent and/or pace of speaking modulation for audio/video streams.

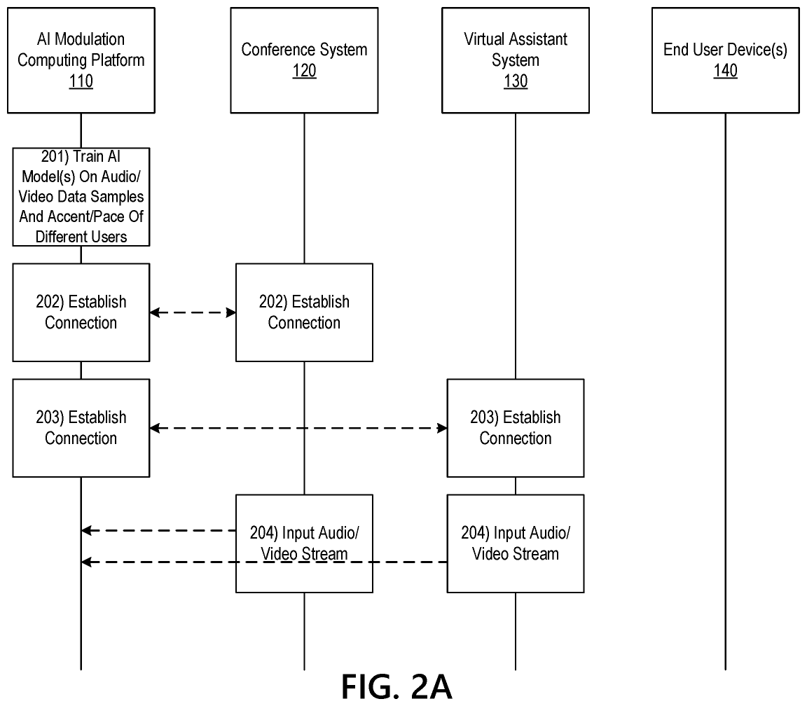

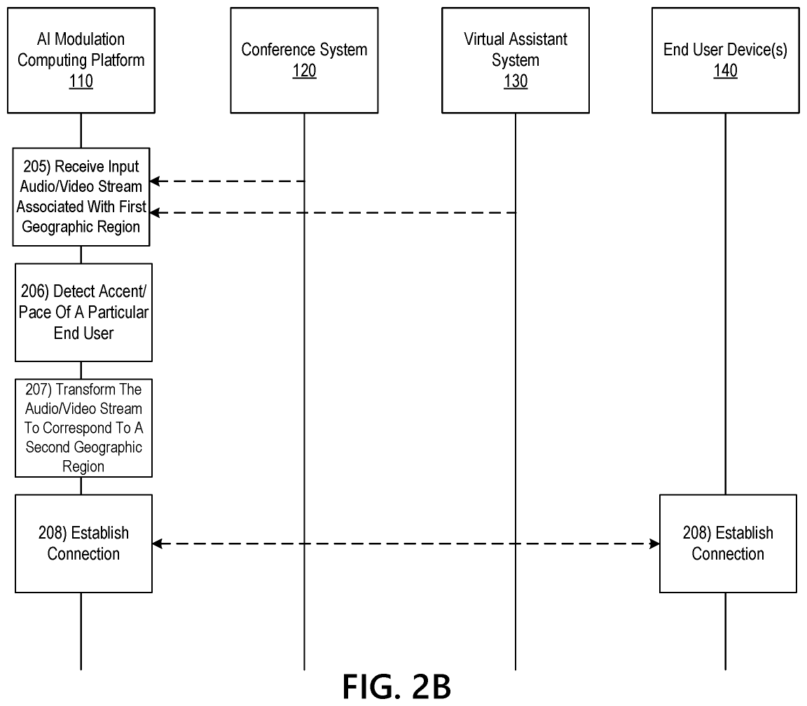

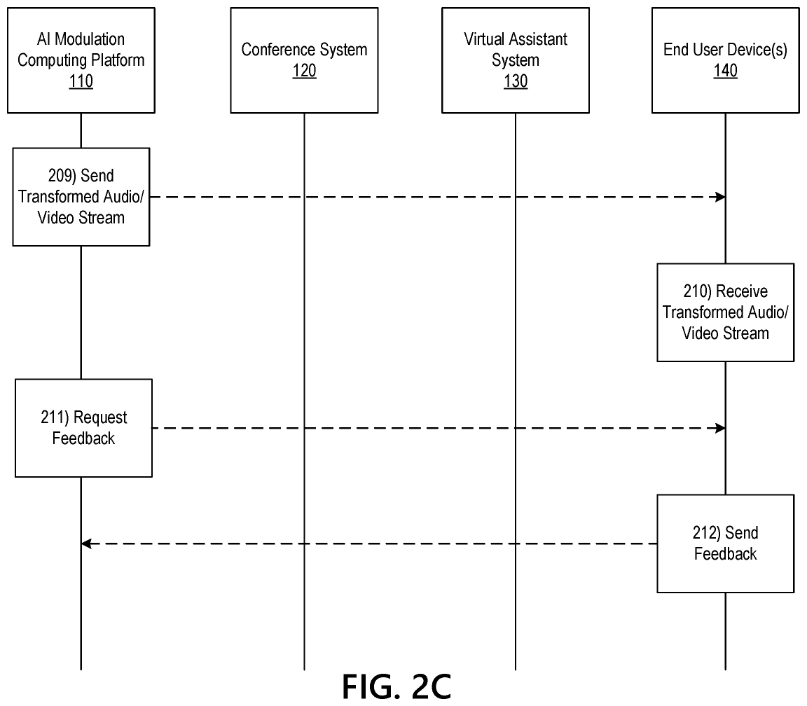

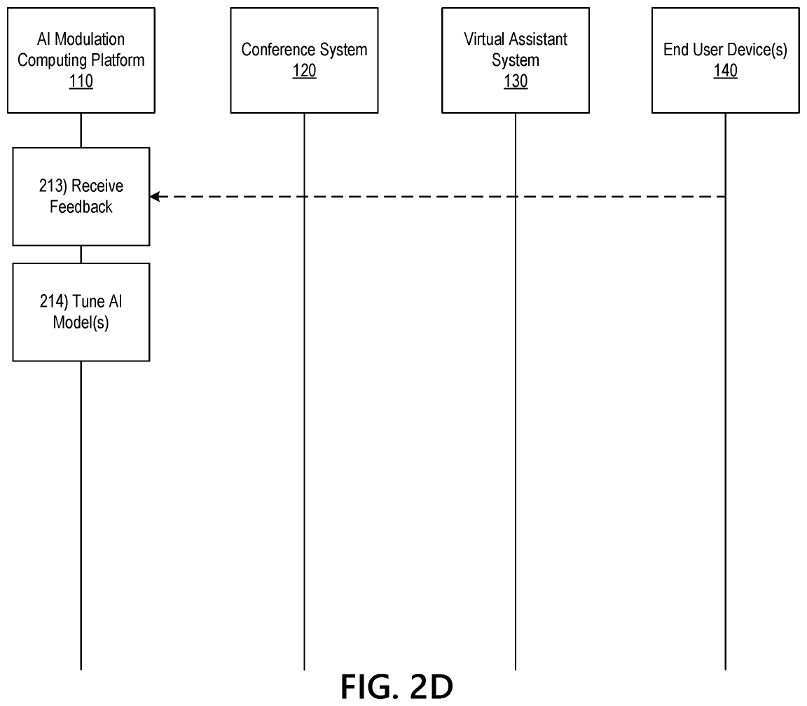

FIGS. 2A-2D depict an illustrative event sequence for generating personalized accent and/or pace of speaking modulation for audio/video streams in accordance with one or more example embodiments. Referring to FIG. 2A, at step 201, AI modulation computing platform 110 may build and/or train one or more artificial intelligence/machine learning models. Various machine learning algorithms may be used without departing from the disclosure, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and/or the like. Additional or alternative machine learning algorithms may be used without departing from the disclosure. In some examples, the machine learning engine 112c may analyze data to identify data patterns and the like, to generate one or more machine learning datasets. The machine learning datasets may include machine learning data linking one identified accent, dialect, or the like to a particular geographic region. Machine learning datasets may include machine learning data linking various other types of data as well, without departing from the disclosure.

For example, memory 112 may have, store, and/or include historical/training data. In some examples, query analysis computing platform 110 may receive historical and/or training data and use that data to train one or more machine learning models stored in machine learning engine 112c. The historical and/or training data may include, for instance, audio and/or video data samples associated with different geographic regions, audio and/or video data samples associated with accent and/or pace of speaking of different users from a plurality of geographic regions or locations, and/or the like. The data may be gathered and used to build and train one or more machine learning models executed by machine learning engine 112c to adjust playback speech audio to a desired or customized accent and/or pace of speaking.

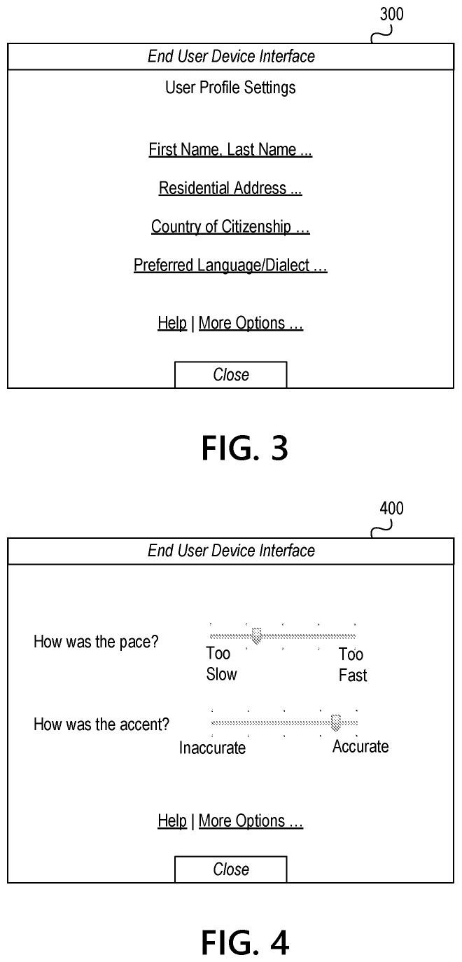

After building and/or training the one or more machine learning models, machine learning engine 112c may receive data from various sources and execute the one or more machine learning models to generate an output, such as a transformed audio/video stream, custom tailored to a desired output (e.g., an expected or desired accent and/or pace of playback speech audio) sought by each individual user, as described in further detail below. In some examples, AI modulation computing platform 110 may already have information associated with language and/or dialect preferences, or, in some cases, AI modulation computing platform 110 may prompt the user for this information. For instance, AI modulation computing platform 110 may cause a computing device (e.g., end user device 140) to display and/or otherwise present a graphical user interface similar to graphical user interface 300, which is illustrated in FIG. 3. As seen in FIG. 3, graphical user interface 300 may include text and/or other information associated with user profile settings (e.g., “[First Name, Last Name . . . ] [Residential Address . . . ] [Country of Citizenship . . . ] [Preferred Language/Dialect . . . ] [Help I More Options . . . ]”).

Returning to FIG. 2A, at step 202, AI modulation computing platform 110 may establish a connection with conference system 120. For example, AI modulation computing platform 110 may establish a first wireless data connection with conference system 120 to link AI modulation computing platform 110 with conference system 120. In some instances, AI modulation computing platform 110 may identify whether or not a connection is already established with conference system 120. If a connection is already established with conference system 120, AI modulation computing platform 110 might not re-establish the connection. If a connection is not yet established with the conference system 120, AI modulation computing platform 110 may establish the first wireless data connection as described above.

At step 203, AI modulation computing platform 110 may establish a connection with virtual assistant system 130. For example, AI modulation computing platform 110 may establish a second wireless data connection with virtual assistant system 130 to link AI modulation computing platform 110 with virtual assistant system 130. In some instances, AI modulation computing platform 110 may identify whether or not a connection is already established with virtual assistant system 130. If a connection is already established with virtual assistant system 130, AI modulation computing platform 110 might not re-establish the connection. If a connection is not yet established with the virtual assistant system 130, AI modulation computing platform 110 may establish the second wireless data connection as described above.

At step 204, conference system 120 and/or virtual assistant system 130 may send, via the communication interface (e.g., communication interface 113) and while the first and/or second wireless data connection is established, an input audio and/or video stream associated with a first geographic region to AI modulation computing platform 110.

Referring to FIG. 2B, at step 205, AI modulation computing platform 110 may receive, via the communication interface (e.g., communication interface 113) and while the first and/or second wireless data connection is established, the input audio and/or video stream associated with the first geographic region. In some examples, the input audio and/or video stream may be associated with a live webcast initiated in the first geographic region and broadcast to user devices located in a second geographic region (e.g., a second geographic region different from the first geographic region). For instance, the input audio and/or video stream may be associated with a live webcast within an enterprise organization initiated in one geographic region and broadcast to enterprise devices located in different regions where the organization has employees and/or offices.

Additionally or alternatively, the input audio and/or video stream may be associated with a natural language interaction application. In some examples, the input audio and/or video stream may be associated with a virtual assistant, a chatbot, an automated teller machine (ATM), and/or other intelligent automated assistant. In some examples, a natural language processing (NLP) system may be deployed at a financial center and a customer may speak with the virtual assistant instead of a human to get assistance at the financial center. The virtual assistant may adapt its accent and/or pace of speaking to customers in the region. Additionally or alternatively, more than generally adapting the output to the accent and/or pace of speaking that is common in the region, AI modulation computing platform 110 may detect the particular user's accent and/or pace of speaking and adapt its responses to the end user's specific accent and/or pace of speaking.

Additionally or alternatively, the input audio and/or video stream may be associated with a live or recorded audio and/or video stream. For instance, the input audio and/or video stream may be associated with training videos, live educational sessions, movies and/or entertainment videos, and/or the like. Similar steps described herein may be performed to transform such audio/video streams in accordance with an expected or desired accent and/or pace of speaking.

In some embodiments, at step 206, AI modulation computing platform 110 may detect or otherwise determine (e.g., via machine learning engine 112c) an accent and/or pace speaking of a particular user (e.g., a specific customer or end user interacting with the system). For example, by detecting the accent and/or pace of speaking of different users, AI modulation computing platform 110 may adapt an audio/video stream to different dialects that are specific to different end users (e.g., transforming an audio and/or video stream specifically to a particular user's accent and/or pace of speaking).

At step 207, AI modulation computing platform 110 may transform the input audio and/or video stream to correspond to a second geographic region (e.g., a second geographic region different from the first geographic region). In some examples, modulation computing platform 110 may apply the trained artificial intelligence (AI) model to convert input speech into a particular or desired accent and/or pace of speaking. For instance, AI modulation computing platform 110 may use artificial intelligence to modify the accent and/or voice that would be modulated with a closest match among different learned accents. In some examples, AI modulation computing platform 110 may adapt responses to the accent and/or pace of speaking of the particular user (e.g., a particular end user in the second geographic region) using the detected accent and/or pace of speaking (e.g., from step 206).

At step 208, AI modulation computing platform 110 may establish a connection with one or more end user device(s) 140. For example, AI modulation computing platform 110 may establish a third/additional wireless data connection(s) with one or more end user device(s) 140 to link AI modulation computing platform 110 with the one or more end user device(s) 140. In some instances, AI modulation computing platform 110 may identify whether or not a connection is already established with the one or more end user device(s) 140. If a connection is already established with the one or more end user device(s) 140, AI modulation computing platform 110 might not re-establish the connection. If a connection is not yet established with the one or more end user device(s) 140, AI modulation computing platform 110 may establish the third/additional wireless data connection(s) as described above.

Referring to FIG. 2C, at step 209, AI modulation computing platform 110 may send, via the communication interface (e.g., communication interface 113) and while the third/additional wireless data connection(s) is established, the transformed audio and/or video stream to a user device (e.g., end user device 140) associated with the second geographic region. For example, AI modulation computing platform 110 may send a transformed audio and/or video stream with modulated (e.g., adjusted) audio or voice data. In turn, at step 210, the user device associated with the second geographic region (e.g., end user device 140) may receive, via the communication interface (e.g., communication interface 113) and while the third/additional wireless data connection(s) is established, the transformed audio and/or video stream. For instance, a playback speech audio adjusted to an expected or desired accent and/or pace of speaking may be played back to the end user (e.g., at end user device 140). Accordingly, based on the manner in which a user speaks, AI modulation computing platform 110 may identify what accent it should deliver back to the user, providing an improved and natural user experience.

In some embodiments, at step 211, AI modulation computing platform 110 may request, via the communication interface (e.g., communication interface 113) and while the third/additional wireless data connection(s) is established, feedback (e.g., user feedback, from end user device 140). For example, AI modulation computing platform 110 may cause the user device (e.g., end user device 140) to display and/or otherwise present one or more graphical user interfaces similar to graphical user interface 400, which is illustrated in FIG. 4. As seen in FIG. 4, graphical user interface 400 may include text and/or other information associated with providing user feedback with respect to the transformed audio and/or video stream (e.g., “How was the pace? [Too Slow . . . Too Fast . . . ] How was the accent? [Inaccurate . . . Accurate . . . ]”). It will be appreciated that other and/or different feedback or input may also be provided.

Returning to FIG. 2C, at step 212, the end user device (e.g. end user device 140) may send, via the communication interface (e.g., communication interface 113) and while the third/additional wireless data connection(s) is established, user feedback to AI modulation computing platform 110. For instance, a user (e.g., of user computing device 140) may provide feedback indicating that the pace of the playback stream was too slow or too fast, that the accent was incorrect, and/or the like.

Referring to FIG. 2D, at step 213, AI modulation computing platform 110 may receive, via the communication interface (e.g., communication interface 113) and while the third/additional wireless data connection(s) is established, the user feedback (e.g., from end user device 140). In turn, at step 214, AI modulation computing platform 110 may update (e.g., tune and/or improve) one or more artificial intelligence/machine learning models (e.g., based on the feedback received from users). Over time, AI modulation computing platform 110 (e.g., via machine learning engine 112c) may learn more and/or different accent and/or paces of speaking that are specific to different countries and/or different regions within countries.

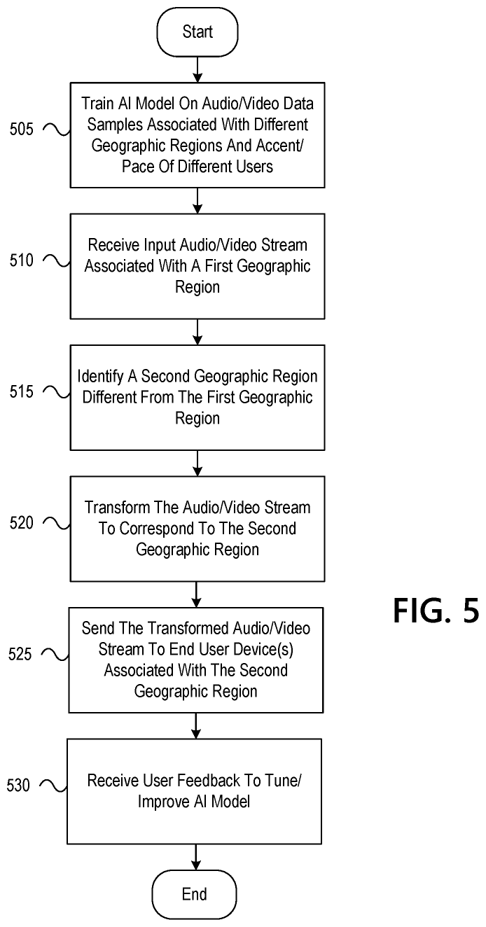

FIG. 5 depicts an illustrative method for generating personalized accent and/or pace of speaking modulation for audio/video streams in accordance with one or more example embodiments. Referring to FIG. 5, at step 505, a computing platform having at least one processor, a communication interface, and memory may train an artificial intelligence model on audio and/or video samples associated with different geographic regions. At step 510, the computing platform may receive an audio and/or video stream associated with a first geographic region. At step 515, the computing platform may identify or receive a second geographic region different from the first geographic region. At step 520, the computing platform may transform the audio and/or video stream to correspond to the second geographic region different from the first geographic region. At step 525, the computing platform may send the transformed audio and/or video stream to a user device associated with the second geographic region. In some embodiments, at step 530, the computing platform may receive user feedback and tune and/or improve the artificial intelligence model based on the user feedback.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
train an artificial intelligence model on audio or video samples associated with different geographic regions;
receive, via the communication interface, an audio or video stream associated with a first geographic region;
identify a second geographic region different from the first geographic region;
transform the audio or video stream to correspond to the second geographic region; and
send, via the communication interface, the transformed audio or video stream to a user device associated with the second geographic region.

2. The computing platform of claim 1, wherein training an artificial intelligence model on audio or video samples associated with different geographic regions comprises training the artificial intelligence model to detect different user accents or paces of speaking.

3. The computing platform of claim 1, wherein the audio or video stream is associated with a live webcast initiated in the first geographic region and broadcast to user devices located in the second geographic region.

4. The computing platform of claim 1, wherein the audio or video stream is associated with a natural language interaction application.

5. The computing platform of claim 1, wherein transforming the audio or video stream to correspond to the second geographic region comprises:
detecting an accent or pace of speaking of a particular user; and
adapting responses to the accent or pace of speaking of the particular user.

6. The computing platform of claim 1, wherein transforming the audio or video stream to correspond to the second geographic region comprises:
applying the trained artificial intelligence model to convert input speech into a particular accent or pace of speaking.

7. The computing platform of claim 1, wherein sending the transformed audio or video stream to the user device associated with the second geographic region comprises sending a transformed audio or video stream with modulated audio or voice data.

8. The computing platform of claim 1, wherein the memory stores additional computer-readable instructions that, when executed by the at least one processor, cause the computing platform to:
receive, via the communication interface, user feedback; and
update the artificial intelligence model based on the user feedback.

9. The computing platform of claim 1, wherein the audio or video stream is associated with a live or recorded audio or video stream.

10. A method, comprising:
at a computing platform comprising at least one processor, a communication interface, and memory:
training, by the at least one processor, an artificial intelligence model on audio or video samples associated with different geographic regions;
receiving, by the at least one processor, via the communication interface, an audio or video stream associated with a first geographic region;
identifying, by the at least one processor, a second geographic region different from the first geographic region;
transforming, by the at least one processor, the audio or video stream to correspond to the second geographic region; and
sending, by the at least one processor, via the communication interface, the transformed audio or video stream to a user device associated with the second geographic region.

11. The method of claim 10, wherein training an artificial intelligence model on audio or video samples associated with different geographic regions comprises training the artificial intelligence model to detect different user accents or paces of speaking.

12. The method of claim 10, wherein the audio or video stream is associated with a live webcast initiated in the first geographic region and broadcast to user devices located in the second geographic region.

13. The method of claim 10, wherein the audio or video stream is associated with a natural language interaction application.

14. The method of claim 10, wherein transforming the audio or video stream to correspond to the second geographic region comprises:
detecting, by the at least one processor, an accent or pace of speaking of a particular user; and
adapting, by the at least one processor, responses to the accent or pace of speaking of the particular user.

15. The method of claim 10, wherein transforming the audio or video stream to correspond to the second geographic region comprises:
applying, by the at least one processor, the trained artificial intelligence model to convert input speech into a particular accent or pace of speaking.

16. The method of claim 10, wherein sending the transformed audio or video stream to the user device associated with the second geographic region comprises sending a transformed audio or video stream with modulated audio or voice data.

17. The method of claim 10, further comprising:
receiving, by the at least one processor, via the communication interface, user feedback; and
updating, by the at least one processor, the artificial intelligence model based on the user feedback.

18. The method of claim 10, wherein the audio or video stream is associated with a live or recorded audio or video stream.

19. One or more non-transitory computer-readable media storing instructions that, when executed by a computing platform comprising at least one processor, a communication interface, and memory, cause the computing platform to:
train an artificial intelligence model on audio or video samples associated with different geographic regions;
receive, via the communication interface, an audio or video stream associated with a first geographic region;
identify a second geographic region different from the first geographic region;
transform the audio or video stream to correspond to the second geographic region; and
send, via the communication interface, the transformed audio or video stream to a user device associated with the second geographic region.

20. The one or more non-transitory computer-readable media of claim 19, wherein the instructions, when executed by the computing platform, further cause the computing platform to:
receive, via the communication interface, user feedback; and
update the artificial intelligence model based on the user feedback.
